(19) United States
(12) Patent Application Publication
(10) Pub. No.: US 2006/0119774 A1
(43) Pub. Date: Jun. 8, 2006

(54) Display device incorporating a phase-change layer

(75) Inventor: Ga-Lane Chen, Fremont, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/293,342

(22) Filed: Dec. 2, 2005

(30) Foreign Application Priority Data
Dec. 3, 2004 (TW) 93137370

(51) Int. Cl. G02F 1/1335

(52) U.S. Cl. 349/114

(57) ABSTRACT

A display device (30) includes a display panel (32) and a backlight module (31). The display panel includes a transparent anode layer (325), a transparent cathode layer (323), and a layer of phase-change material (324) sandwiched therebetween. The backlight module is arranged adjacent the display panel. The display device utilizes a phase-change material to serve as a light switch and can fully make use of the available light emitted from the backlight module for display purposes, thereby permitting a high utilization efficiency of light to be realized. In addition, the function of a light switch is achieved by the electron transition occurring in the phase-change material. Because the time of such an electron transition is very short, the response time of the display panel is thus decreased.

### BACKGROUND OF THE INVENTION

1. Field of the Invention

The present invention relates to a display device and, more particularly, to a flat panel display (FPD) device with high utilization efficiency of light.

2. Discussion of the Related Art

In order to display words and/or images, a display device is generally used. Up to now, various display devices, such as cathode-ray tube (CRT) displays, FPDs, etc., have been developed. Specially, liquid crystal display (LCD) devices, as one kind of a FPD, have been used in a variety of fields due to their compact size and low power consumption.

Unlike the CRT display, a liquid crystal panel of an LCD device does not itself emit light. Instead, in a conventional transmissive LCD device, an illuminator, i.e. a backlight module, is provided at a rear side of the LCD device. The liquid crystal of the liquid crystal panel of the LCD device typically functions as a light switch. Specifically, the liquid crystal controls the transmission of light from the backlight module, thereby displaying the images. However, in the transmissive LCD device, the backlight module consumes 50% or more of the total power consumed by the LCD device. That is, the backlight module is a major contributor to power consumption. In addition, because a polarizer is a typically necessary element in the LCD device and only polarized light can pass the polarizer, about 50% or more of the light emitted from the backlight module 10 still cannot be utilized.

In order to overcome the above problem, a reflective LCD device has been developed for portable information apparatuses which are often used outdoors or in places where artificial ambient light is available. The reflective LCD device is provided with a reflector formed on a rear side of a liquid crystal panel associated therewith, instead of having a backlight module. Ambient light is reflected by the reflector, in order to illuminate the liquid crystal panel.

However, using the reflection of ambient light is disadvantageous, because the visibility of the liquid crystal panel is extremely low when the surrounding environment is dark. Conversely, the transmissive LCD device is disadvantageous when the surrounding environment is bright and could sufficiently illuminate the LCD, if it were to instead function in a reflective mode.

In order to overcome the above problems, an apparatus which realizes both a transmissive display and a reflective display in a single LCD device has been developed. The apparatus is called as a transflective LCD device. Referring to FIG. 2, a conventional transflective LCD device 1 mainly includes an upper transparent substrate 12 and a lower transparent substrate 11 disposed opposite therefrom. A liquid crystal layer 13 is disposed between the upper and lower transparent substrates 12 and 11. A backlight module 10 is disposed under the lower transparent substrate 11 and is configured for providing illumination for the transflective LCD device 1, as needed.

A quarter wave plate 122 and an upper polarizer 121 are sequentially stacked one on top of the other on a surface of the upper transparent substrate 12 that is opposite from the liquid crystal layer 13. A transparent common electrode 14 and a homogeneous alignment film 18 are sequentially stacked on one another on a surface of the upper transparent substrate 12 that faces the liquid crystal layer 13. A quarter wave plate 112 and a lower polarizer 111 are sequentially stacked on a surface of the lower transparent substrate 11 that faces the backlight module 10.

With further respect to the above transflective LCD device, a transparent electrode 17, a passivation layer 16, a reflective electrode 15, and a homogeneous alignment film 19 are sequentially stacked on one another on a surface of the lower transparent substrate 11 that faces the liquid crystal layer 13. A plurality of transmissive holes 151 is defined and spans from the reflective electrode 15 through the passivation layer 16 and to the transparent electrode 17. Optical axes of the upper and lower polarizers 121, 111 are perpendicular to each other.

A first cell gap d11 is defined between the reflective electrode 15 and the transparent common electrode 14, i.e., a reflective portion. A second cell gap d12 is defined between the transparent electrode 17 and the transparent common electrode 14, i.e., a transmissive portion. The thickness of the liquid crystal layer 13, i.e., the cell gaps, is therefore not constant. Preferably, the second cell gap d12 is twice as wide as the first cell gap d11. When the transflective LCD device 1 is in an on state, part of the light emitted from the backlight module 10 transmits through the transmissive portion and is used in a transmissive mode, and part of the ambient light is reflected by the reflective electrode 15 and is used in a reflective mode. Thus, the transflective LCD device 1 provides a transflective display function. However, when the transflective LCD device 1 is used in a transmissive mode, about 50% or more of the light emitted from the backlight module 10 still cannot be utilized because only polarized light can pass the polarizers 121, 111. The utilization efficiency of the light is still low.

In order to improve the utilization efficiency of the light, another conventional LCD device 20, as shown in FIG. 3, has been developed. The LCD device 20 includes a liquid crystal panel 21 and a backlight module 22. The liquid crystal panel 21 includes a first substrate 211, a liquid crystal layer 212, and a second substrate 213. The backlight module 22 includes two light sources 221, two light source covers 222, two light guide plates (LGPs) 224, a reflective sheet 223, a diffusing sheet 225, a brightness enhancement film 226, a reflective polarizer 227, and a cover layer 228.

FIG. 4 shows a light path of the backlight module 22 of the LCD device 20 in FIG. 3. A natural light composed of P-polarized light and S-polarized light is firstly emitted from the two light sources 221. The polarization directions of the P-polarized light and S-polarized light are perpendicular to each other. The natural light transmits through the LGPs 224, the diffusing sheet 225, and the brightness enhance film 226, and then reaches the reflective polarizer 227. The S-polarized light can pass the reflective polarizer 227, since the polarization direction thereof is parallel to that of the reflective polarizer 227. The P-polarized light cannot pass the reflective polarizer 227 and is reflected by the reflective polarizer 227, as the polarization thereof is perpendicular to that of the reflective polarizer 227. The reflected P-polarized light transmits through the brightness enhancement film 226, the diffusing sheet 225, and the LGPs 224; potentially, is reflected by the reflective sheet 223; and then is changed into P-polarized light and S-polarized light again. Thus, the changed S-polarized light is reused. The light utilization efficiency of the LCD device 20 is higher than that of the LCD device 10. However, given that the light needs to pass through a plurality of interfaces, such as the brightness enhance film 226, the diffusing sheet 225, the light guide plates 224, etc., the light may be significantly attenuated after passing through the interfaces. Thus, the light utilization efficiency of the LCD device 20 is not satisfactory.

What is needed, therefore, is a display device with high utilization efficiency of light.

### SUMMARY OF THE INVENTION

A display device according to one preferred embodiment includes a display panel and a backlight module. The display panel includes a transparent anode layer, a transparent cathode layer, and a layer of phase-change material sandwiched therebetween. The backlight module is arranged adjacent the display panel.

Comparing with conventional LCD devices, the present display device has following advantages. The natural light emitted from the light source in the conventional LCD device with polarizer needs to be transformed into P-polarized light or S-polarized light, and only one of the P-polarized light and S-polarized light can be utilized for display. The present display device utilizes a phase-change material to serve as a light switch and can fully make use of the light emitted from the backlight module, for illuminating the display device. Accordingly, a high utilization efficiency of light is achieved with the current display device. In addition, the function of a light switch is achieved by the electron transition occurring in the phase-change material. Because the time of any given electron transition is very short, the response time of the display panel is thus decreased.

Other advantages and novel features will become more apparent from the following detailed description of present display device, when taken in conjunction with the accompanying drawings.

### BRIEF DESCRIPTION OF THE DRAWINGS

Many aspects of the present display device can be better understood with reference to the following drawings. The components in the drawings are not necessarily to scale, the emphasis instead being placed upon clearly illustrating the principles of the present display device. Moreover, in the drawings, like reference numerals designate corresponding parts throughout the several views.

FIG. 1 is a schematic, side view of a display device in accordance with a preferred embodiment;

FIG. 2 is a schematic, cross-sectional view of a conventional transflective LCD device;

FIG. 3 is a schematic, side view of another conventional LCD device; and

FIG. 4 shows a light path of a backlight module of the LCD device of FIG. 3.

### DETAILED DESCRIPTION OF PREFERRED EMBODIMENTS

Reference will now be made to the drawings to describe preferred embodiment of the present display device, in detail.

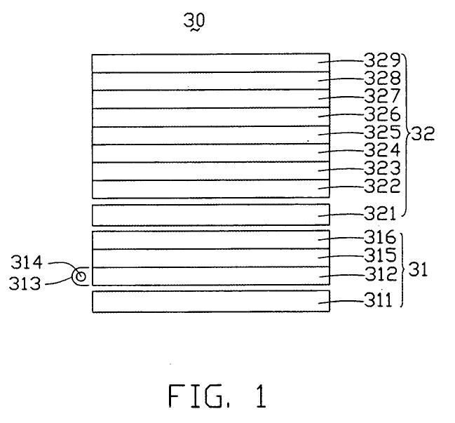

Referring to FIG. 1, a display device 30, in accordance with a preferred embodiment, is shown. The display device 30 includes a backlight module 31 and a display panel 32. The backlight module 31 is placed under the display panel 32 and provides the light to illuminate the display panel 32, as needed.

The backlight module 31 includes a light source 314, a light source cover 313, an LGP 312, a reflective sheet 311, a diffusing sheet 315, and a light condenser 316. The light source 314 is placed at one side, i.e., an incidence surface of the LGP 312. The light source 314 is generally, e.g., a light emitting diode (LED) or a cold cathode fluorescence lamp (CCFL). The light source cover 313 partly surrounds the light source 314. The reflective sheet 311, the LGP 312, the diffusing sheet 315 and the light condenser 316 are arranged in that order. The LGP 312 is used for guiding light to exit from a light emitting surface thereof. The reflective sheet 311 is coated with a layer of, e.g., silver or aluminum and reflects at least part of the light exiting from a bottom surface of the LGP 312. The light condenser 316 has a prism structure for collimating diffused light emitting from the diffusing sheet 315.

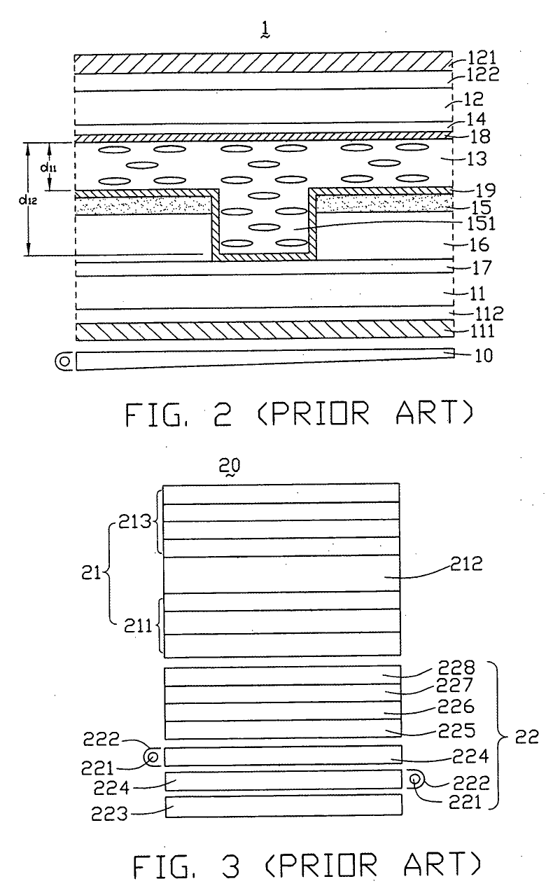

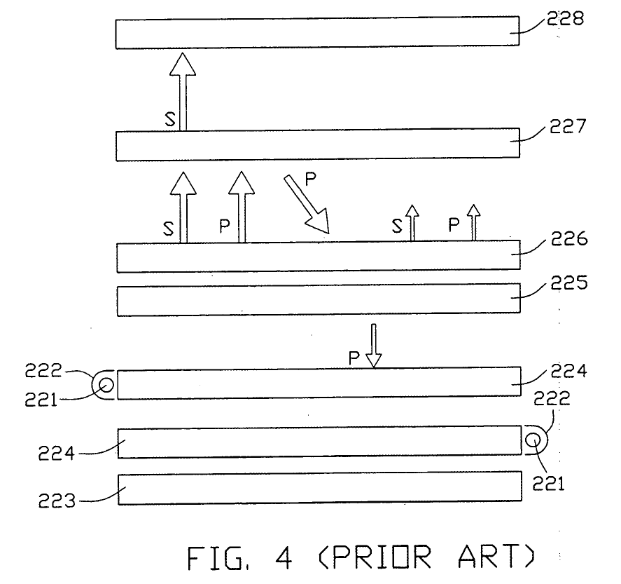

The display panel 32 includes a lower transparent substrate 321, an upper transparent substrate 327, and a layer of phase-change material 324 sandwiched therebetween. Advantageously, further, a color filter 326 is arranged on a surface of the upper transparent substrate 327 that faces the layer of phase-change material 324. Of additional benefit, an anti-glare layer 328 and an anti-reflection layer 329 are sequentially stacked one on top of the other on a surface of the upper transparent substrate 327, that surface being opposite from the layer of phase-change material 324. A thin film transistor (TFT) layer 322 is arranged on a surface of the lower transparent substrate 321 that faces the layer of phase-change material 324. The TFT layer 322 includes a TFT array corresponding with a pixel array of the display device 30. Furthermore, a transparent anode layer 325 is sandwiched between the layer of phase-change material 324 and the color filter 326. Yet additionally, a transparent cathode layer 323 is sandwiched between the layer of phase-change material 324 and the TFT layer 322. Note that the usage of the layer of phase-change material 324 in the present design eliminates the need for a liquid crystal layer to properly create a display. Unlike the light emitted from the light source 221 in the LCD device 20 (referring to FIG. 3) needs to be transformed into P-polarized light or S-polarized light, with only one of the P-polarized light and S-polarized light then being utilized for display, the present design does not need to do that. As such, the present display device 30, while incorporating much of the structure of a typical LCD device, operates in fundamentally different manner, thereby avoiding the problems associated with typical LCD devices.

The layer of phase-change material 324 can be made of a pigment, dye, or other similar organic material, etc. A thickness of the layer of phase-change material 324 is usefully in the range from about 100 nm to about 500 nm and is preferably in the range from about 200 nm to 400 nm. The transparent anode layer 325 and the transparent cathode layer 323 are deposited on respective sides of the layer of phase-change material 324. The transparent anode layer 325 and the transparent cathode layer 323 are comprised, e.g., of an indium tin oxide (ITO) material or another suitably transparent and conductive material. An appropriate voltage can be generated by each TFT of the TFT layer 322 and can be applied between the transparent anode layer 325 and the transparent cathode layer 323 corresponding with one pixel of the display device 30.

Because the layer of phase-change material 324 is sandwiched between the transparent anode layer 325 and the transparent cathode layer 323, when the voltage is applied between the transparent anode layer 325 and the transparent cathode layer 323 corresponding with one pixel of the display device 30, the corresponding portion of the layer of phase-change material 324 becomes excited. An electron transition then occurs in the phase-change material, thereby producing a plurality of pairs of electrons and holes. Under this situation and as a result of electro-optic effect, the corresponding portion of the layer of phase-change material 324 can let the light transmit therethrough from the backlight module 31. When there is no voltage being applied between the transparent anode layer 325 and the transparent cathode layer 323 corresponding with one pixel of the display device 30, the corresponding portion of the layer of phase-change material 324 becomes unexcited, and the light cannot pass therethrough. Therefore, the layer of phase-change material 324 can function as a light switch and can control whether the light passes therethrough or not.

In operation, a uniform planar light generated by the backlight module 31 illuminates the display panel 32. When there is no voltage being applied between the transparent anode layer 325 and the transparent cathode layer 323 corresponding with one pixel of the display device 30, the corresponding portion of the layer of phase-change material 324 is operated in an “off state,” during which the light cannot pass therethrough. When a voltage is applied between the transparent anode layer 325 and the transparent cathode layer 323 corresponding with the pixel of the display device 30, and the corresponding portion of the layer of phase-change material 324 is excited thereby, The portion of the layer of phase-change material 324 is operated in an “on state,” during which the light can thus pass therethrough. The voltages generated by the TFT layer 322 are controlled by signals corresponding with words and/or images to be displayed, so under actions of all elements of the TFT layer 322, the voltages generate a plurality of electric fields, which in turn, are applied to corresponding pixels of the display panel 32. The light flux through the layer of phase-change material 324 at each pixel is accurately controlled by the corresponding electric field. The color and brightness of light are also controlled by the electric fields. Thus, the display panel 32 can display words and/or images.

Comparing with conventional LCD devices, the present display device 30 has following advantages. The light emitted from the light source in the typical LCD device needs to be transformed into P-polarized light or S-polarized light, and only one of the P-polarized light and S-polarized light (i.e., effectively about half the total light output of the light source/backlight module) can be utilized for display. The present display device 30 utilizes a phase-change material to serve as a light switch and can fully make use of the light emitted from the backlight module for illuminating the display device. Accordingly, a high utilization efficiency of light is achieved with the current display device 30. In addition, the function of a light switch is achieved by the electron transition occurring in the phase-change material. Because the time of any given electron transition is very short, the response time of the display panel is thus decreased, facilitating potentially rapid changes in the displayed image, which is quite useful in a video display unit.

It is to be understood that the above-described embodiment is intended to illustrate rather than limit the invention. Variations may be made to the embodiment without departing from the spirit of the invention as claimed. The above-described embodiments are intended to illustrate the scope of the invention and not restrict the scope of the invention.

What is claimed is:

1. A display device, comprising:
a display panel having a transparent anode layer, a transparent cathode layer, and a layer of a phase-change material sandwiched therebetween; and
a backlight module arranged adjacent the display panel.

2. The display device as claimed in claim 1, wherein the layer of phase-change material is comprised of one of a pigment and dye.

3. The display device as claimed in claim 1, wherein a thickness of the layer of phase-change material is in the approximate range of from 100 nm to 500 nm.

4. The display device as claimed in claim 3, wherein a thickness of the layer of phase-change material is about in the range from 200 nm to 400 nm.

5. The display device as claimed in claim 1, wherein the transparent anode layer and the transparent cathode layer are comprised of an indium tin oxide material, the transparent anode layer and the transparent cathode layer being deposited on opposite sides of the layer of the phase-change material.

6. The display device as claimed in claim 1, wherein an upper transparent substrate is arranged on a surface of the transparent anode layer that is opposite from the layer of the phase-change material, and a lower transparent substrate is arranged on a surface of the transparent cathode layer that faces the backlight module.

7. The display device as claimed in claim 6, wherein a color filter is sandwiched between the upper transparent substrate and the transparent anode layer, and an anti-glare layer and an anti-reflection layer are sequentially arranged on a surface of the upper transparent substrate, the surface of the upper transparent substrate being opposite from the layer of the phase-change material.

8. The display device as claimed in claim 6, wherein a thin film transistor layer is sandwiched between the lower transparent substrate and the transparent cathode layer.

9. A display panel comprising a transparent anode layer, a transparent cathode layer, and a layer of a phase-change material sandwiched therebetween, the layer of the phase-change material being configured for functioning as a light switch when a voltage is applied between the transparent anode layer and the transparent anode layer.

10. The display panel as claimed in claim 9, wherein the layer of the phase-change material is comprised of one of a pigment and dye.

11. The display panel as claimed in claim 9, wherein a thickness of the layer of phase-change material is approximately in the range from 100 nm to 500 nm.

12. The display panel as claimed in claim 9, wherein the transparent anode layer and the transparent cathode layer are comprised of an indium tin oxide material, the transparent anode layer and the transparent cathode layer being deposited on opposite sides of the layer of the phase-change material.

13. The display panel as claimed in claim 9, wherein an upper transparent substrate is arranged on a surface of the transparent anode layer opposite the layer of the phase-change material, and a lower transparent substrate is arranged on a surface of the transparent cathode layer opposite the layer of the phase-change material.

14. The display panel as claimed in claim 13, wherein a color filter is sandwiched between the upper transparent substrate and the transparent anode layer, and an anti-glare layer and an anti-reflection layer are sequentially arranged on a surface of the upper transparent substrate opposite from the layer of the phase-change material.

15. The display panel as claimed in claim 13, wherein a thin film transistor layer is sandwiched between the lower transparent substrate and the transparent cathode layer.
